(19) United States
(12) Patent Application Publication
(10) Pub. No.: US 2007/0237989 A1
(43) Pub. Date: Oct. 11, 2007

(54) POWER SOURCE SYSTEM USING A FUEL CELL AND ITS CONTROL METHOD

(76) Inventors: Yasuaki Norimatsu, Hitachinaka (JP); Akihiko Kanouda, Hitachinaka (JP); Mutsumi Kikuchi, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/679,942

(22) Filed: Feb. 28, 2007

(30) Foreign Application Priority Data
Apr. 6, 2006 (JP) 2006-104815

(51) Int. Cl. H01M 16/00; H01M 8/04; H01M 10/46

(52) U.S. Cl. 429/9; 429/23; 320/101

(57) ABSTRACT

A control method of a power source system having at least two kind of power supply, such as a fuel cell and an auxiliary power supply and supplying power to electronic devices, the fuel cell characteristics being recovered by increasing the fuel cell output voltage.

### CLAIM OF PRIORITY

This application claims priority from Japanese application serial No. 2006-104815, filed on Apr. 6, 2006, the content of which is hereby incorporated by reference into this application.

### BACKGROUND OF THE INVENTION

This invention relates to an electric power source system using a fuel cell and its control method.

Recently, portable electronic devices such as portable phones, notebook type personal computers, audiovisual devices, or mobile terminal devices have quickly come into vide use. Such portable electronic devices are driven by secondary batteries. From the view point of realizing new batteries with small size, light weight, and high energy density, the secondary batteries have been sifted from sealed lead-acid batteries into Ni/Cd cells, Ni-Hydrogen cells and Li ion cells. In any second battery, the development for active substances of cell and cell structure with high power capacity have been carried out and efforts is required to realize an electric power source system with longer use hours.

It is required to realize lower power consumption in the electronic devices. New functions are added to them in order to satisfy the user's needs. Therefore, there is a tendency to increase the total power consumption. A new electric power source system with higher density and continuous long use hour is necessary.

In realizing a secondary battery with continuous and long use hours, length of its charging time is a problem to be solved. Therefore, necessity of small size generator without charging step have been increased, and it is considered to use fuel cells as an appropriate measure. A fuel cell type using hydrogen gas obtained through reforming is generally well-known. The operation temperature reaches to more than 80° C. To the contrary, another type of fuel cell operable at room temperature which oxidizes the fluid fuel directly at a fuel pole is known.

A direct methanol fuel cell (hereinafter referred to as DMFC) which oxidizes the methanol directly is cited as a typical fuel cell. As having high safety for the temperature, the DMFC is applied to many kinds of portable devices as shown in Japanese laid open patent publication 2002-32154.

### SUMMARY OF THE INVENTION

There is a phenomenon that the output voltage of the fuel cell gradually reduces when the fuel cell is operated continuously under the constant current control and constant power control and as a result, the output characteristics reduces.

An object of the present invention is to provide an electric power source system and its control method being capable of recovering the output characteristics of the fuel cell.

A feature of the invention is to propose a control method of the electric power source system having at least two kinds of electric power sources such as a fuel cell and an auxiliary power supply supplying power to the electronic devices, and recovering the fuel cell characteristics by increasing the fuel cell voltage.

According to the present invention, it is capable of recovering the output characteristics fallen down due to the continuous operation.

The DMFC generates the electric power by supplying methanol solution to a fuel pole (negative pole) and oxygen (air) to an air pole (positive pole), respectively. A fuel cell which at least one of the methanol solution and oxygen (air) is supplied by controlling a pump and a fan is called an active type.

On the other hand, a fuel cell which uses spontaneous diffusion without using the above apparatus is called a passive type. In the active type fuel cell, to prevent reduction of generation power capacity, bubbles and water drops stuck to the pole are compulsory washed away and removed by feeding the methanol solution and air by the pump and the fan.

There is a phenomenon that continuous operation reduces the voltage of the fuel cell gradually by occurrences of carbon oxide (CO) and hydrogen peroxide (H2O2) at poles and it has much influence on the life time of the fuel cell.

### The above voltage reduction has a bad influence such as change of the voltage polarity of the DMFC and when the voltage decreases extremely, its lifetime also decreases.

According to the following embodiments, it is capable of guaranteeing long life time of the DMFC as well as continuous long operation time in comparison with an ordinary electronic devices.

According to the power source system of the embodiment, reduction of generating area of the DMFC and/or miniaturization of an auxiliary accumulator is realized by increasing the DMFC electric power. Therefore, the size of the electronic devices becomes small.

### BRIEF EXPLANATION OF THE DRAWINGS

FIG. 1 is a circuit diagram showing the first embodiment according to the present invention;

FIG. 2 is a graph showing recovery of the output characteristics by increasing the DMFC voltage;

FIG. 3 is the graph showing the relationship of the DMFC output voltage, current density and the distance between the air pole and the barrier wall;

FIG. 4 is a flow chart explaining operation of the determining/control section of the first embodiment according to the present invention;

FIG. 5 is a flow chart explaining operation of the determining/control section of the first embodiment according to the present invention;

FIG. 6 is a flow chart explaining operation of the determining/control section of the first embodiment according to the present invention;

FIG. 7 is a flow chart explaining operation of the determining/control section of the first embodiment according to the present invention;

FIG. 8 is an appearance view when the fuel cell is mounted on the portable phone;

FIG. 9 is a view showing the structure when the fuel cell is mounted on the portable phone;

FIG. 10 is an appearance view when the fuel cell is mounted on the portable phone;

FIG. 11 is a view showing the structure when the fuel cell is mounted on the portable phone;

FIG. 12 is a circuit diagram showing the second embodiment according to the present invention;

FIG. 13 is a circuit diagram showing the DC/DC converter of the second embodiment;

FIG. 14 is a flow chart explaining operation of the determining/control section of the second embodiment according to the present invention;

FIG. 15 is a flow chart explaining operation of the determining/control section of the second embodiment according to the present invention;

FIG. 16 is a flow chart explaining operation of the determining/control section of the first embodiment according to the present invention;

FIG. 17 is a appearance view when the power source system is mounted on the notebook type personal computer;

FIG. 18 is a appearance view when the Li secondary cell is mounted on the electronic device;

FIG. 19 is a graph explaining the relation between the limit control and PMFC characteristics of the first embodiment; and

FIG. 20 is a diagram explaining function of the control integral circuit in the first embodiment.

### DETAILED EXPLANATION OF THE PREFERRED EMBODIMENTS

The embodiments of the power source system and its control method in accordance with the present invention are explained hereinafter with reference to attached drawings.

The control method of the embodiment is explained below. The causes of the voltage reduction under generation operation are pole catalyst poisoning (CO and hydrogen oxide), prevention of feeding due to reaction products (carbon oxide of the fuel pole, water of an air pole), blocking of the air pole, fuel run out and so on.

Firstly, it is considered that the cathode (air pole) potential reduction causes the output characteristics reduction of the DMFC through poisoning of its poles. Therefore, under the constant power load condition, inventors tried to remove the pole poisoning by keeping the current value from the DMFC low thereby reducing the load power, and once to increase the DMFC output voltage (‘recovery operation).

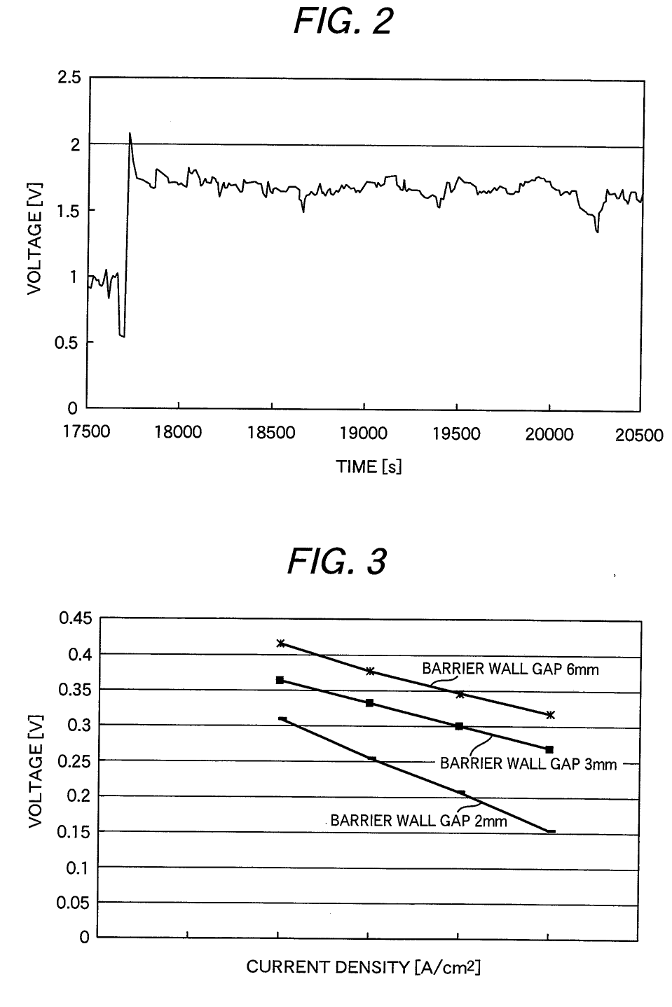

After the above recovery operation, the inventors increases again the power load up to the same level as that the voltage reduction occurred, As a result, as shown in FIG. 2, it was confirmed that the output voltage of the DMFC did not reduce to the same level as that before the recovery operation, and the output characteristics recovered.

In case feeding prevention due to reaction products causes output voltage reduction, and a phenomenon which reduces the DMFC voltage suddenly is found. It is able to prevent from getting worse by current reduction of the DMFC, the characteristics can be recovered by spontaneous diffusion of carbon oxide and water.

When the cause is the air pole blocking, its behavior is similar to the above reaction products. It was confirmed that the characteristics was changed depending on the way of blocking. In the case of the above, the recovering by controlling DMFC is not possible, it requires to reduce the output of the DMFC so as not to change a vapor of the air pole into a liquefied state.

When the cause is fuel run out, the output decreases according to reduction of the DMFC open voltage where the fuel of the fuel cell pole decreases below a predetermined concentration. It is not able to recover by controlling of the DMFC, however a measure is required to stop load control by the DMFC.

Next, method and its structure for recovering the characteristics by classifying causes of the output characteristics reduction are explained in detail hereinafter.

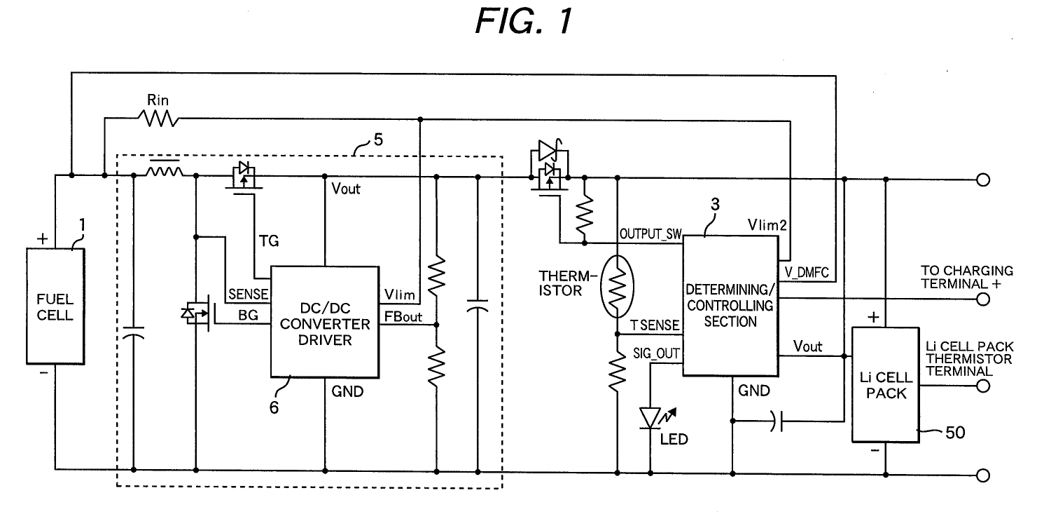

As shown in FIG. 1, an embodiment of the invention generally, comprises a fuel cell 1, Li cell pack 50 as an accumulation means, a DC/DC converter 5, and a determining/control section 3. Each structure and operation is explained below.

A Li cell pack 50 is used as the electric accumulation means in the above embodiment, however, it is applicable to devices (for example, potable phone, PDA, digital still camera, multimedia player and so on) driven by one cell of the Li cell and two cell of NiMH. In case the Li cell is structured by a plurality of cells, the number of the cell may be selected according to its use, for example, a notebook type personal computer.

It is possible to use the electric double layer capacitor as an accumulation means in place of the Li cell pack 50. By mounting the accumulation system as shown in FIG. 1, it becomes capable of compensating shortage power when the demand power is larger than the fuel cell maximum power. For example, temporary reduction of the fuel cell voltage and pulse load, such as the portable phone are considered.

In applying the present invention to a device which has a lot of pulse load, it is recommended to use the electric double layer capacitor superior to others in discharging characteristics for improving the efficiency.

The embodiment uses the DMFC as the fuel cell, however, other kind of fuel cell is available. A DC/DC converter 5 comprises a synchronous rectifying voltage step up converter using an N channel power MOS FET 52 and a P channel power MOSFET 54. In addition to the electric double layer capacitor 2, filtering capacitors are connectable to the input and output terminals.

In FIG. 1, N channel MOS FET is used as the load interruption switch, however, P channel power MOSFET and other switching elements may be used.

A DC/DC converter driver 6 has at least seven terminals, that is, a fuel cell voltage restriction terminal (Vlim), an output voltage value obtaining terminal (Fbout), output voltage value and power source obtaining terminals (Vout), a switch current obtaining terminal (sense), P channel MOS FET control terminal (TG), N channel power MOSFET control terminal (BG), and a ground terminal (GND). Additionally, an ON/OFF terminal of the DC/DC converter driver 6 and a loop compensation terminal may provide, if necessary.

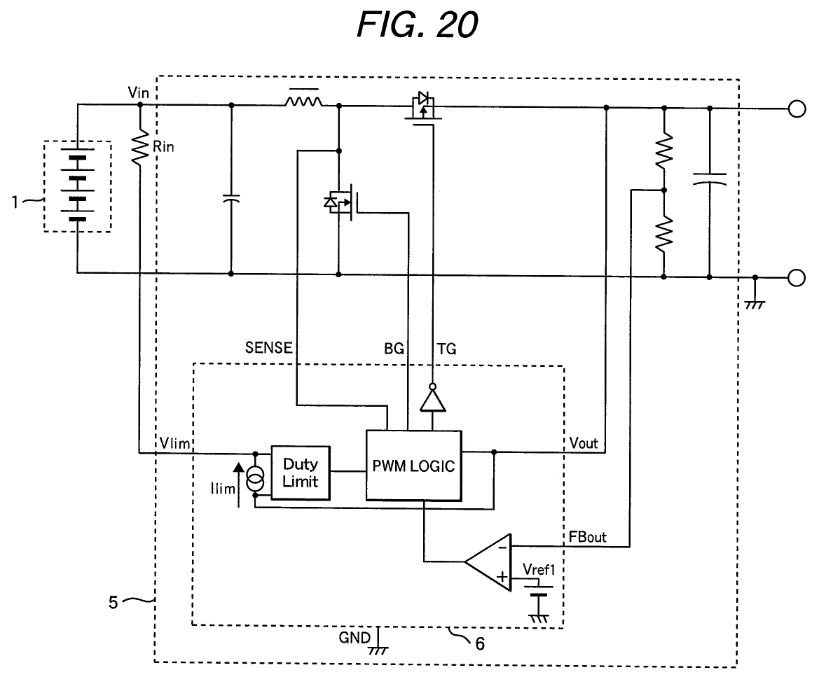

An example of the function diagram of the DC/DC converter is shown in FIG. 20. The first feature of the invention lies in treating the restriction voltage Vlim. As the embodiment structure is a step up type, very small constant current Ilim flows from a Vout terminal to a Vlim terminal through a constant current circuit. The structure comprises a function performing duty restriction in proportional to the voltage value of Vout-Vlim, and another function to stop completely the switching operation of PWM when the restriction voltage Vlim reduces below a predetermined voltage.

If a voltage which completely stops the PWM operation is expressed by Vstop, the following equation holds.

Vstop=Ilim×Rin+Vin

Therefore, by selecting the voltage Vin so as to be a voltage value at a maximum power point where the fuel cell power becomes maximum, it is possible to certainly restrict the output voltage Vout within current range till the maximum power point,

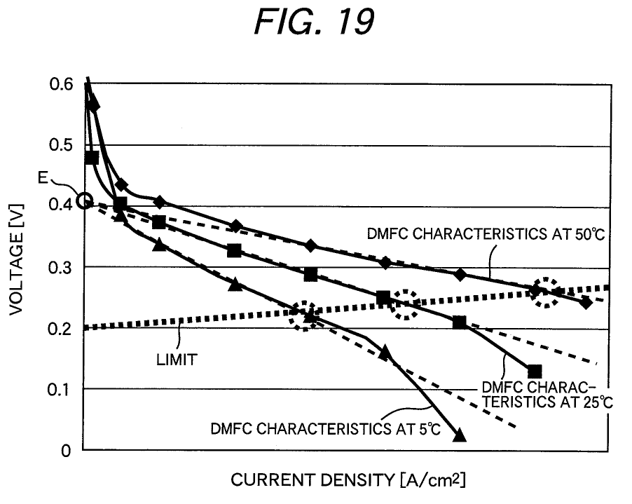

When the voltage Vin of the fuel cell falls down below the voltage Vstop by the fuel cell run out and shortage of oxygen, switching operation is stopped safely. The relation between DMFC characteristics and the restriction is shown in FIG. 19. The switching operation is done at the intersection point of the PMFC characteristics line and restriction line, it is capable of preventing more voltage reduction,

When the DMFC characteristics is different from FIG. 19 and the DMFC voltage is lower than the restriction voltage Vlim, the switching operation is stopped.

When the DMFC voltage reduces blow a predetermined value, if the fuel cell is controlled so as to recover the fuel cell voltage, the DMFC is operated keeping over a predetermined value. Although the predetermined voltage value is selectable arbitrarily, by setting voltage value at an intersection point E, see FIG. 19, where extension line of inclination of the output voltage characteristics corresponding to the current density of the fuel cell within the range except vicinity of current zero intersects the output current zero line, it is able to obtain high voltage value for low current value, and lengthen the lifetime of the fuel cell efficiently.

A second feature of the present embodiment lies in treating the voltage FBout at the output voltage obtaining terminal. The structure is analogous to the output voltage feedback in an ordinary DC/DC converter. When the output power<<maximum fuel cell power, the control of the output voltage become constant control and there is no change in comparison with an usual DC/DC converter.

When the output power approached to the maximum power of the fuel cell to some degree, restricted duty control of the PWM begins. When the output power≧the fuel cell power, the shortage power is output by the accumulation means provided on the output side and the output is determined according to the charging condition of the accumulation means. Accordingly, the PWM continues operation at restricted maximum duty of the PWM and fall down the output voltage.

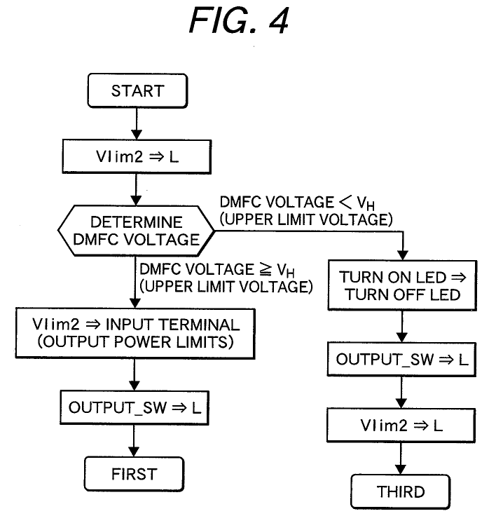

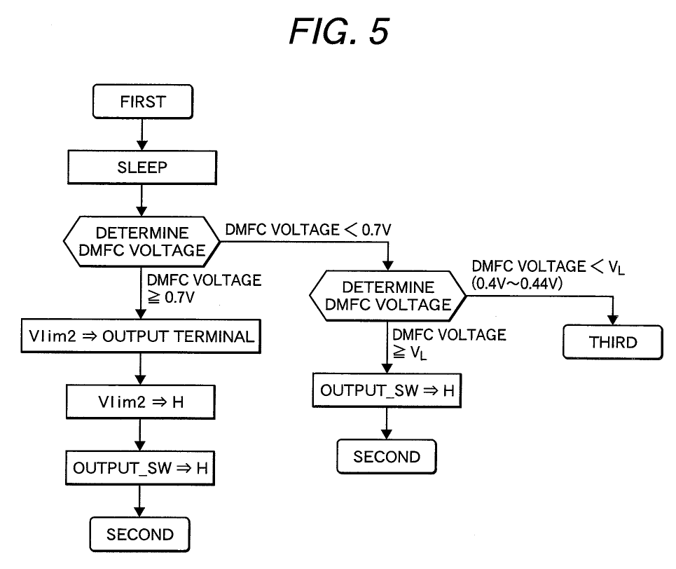

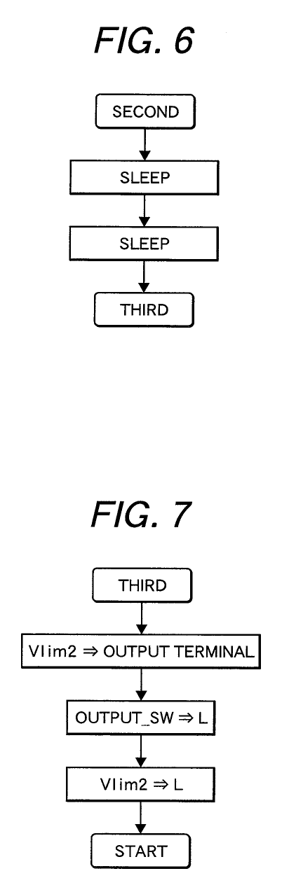

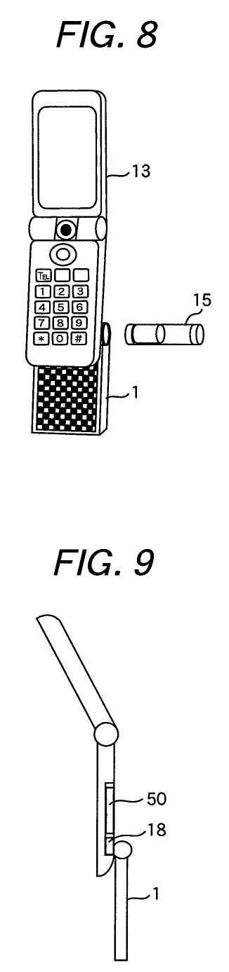

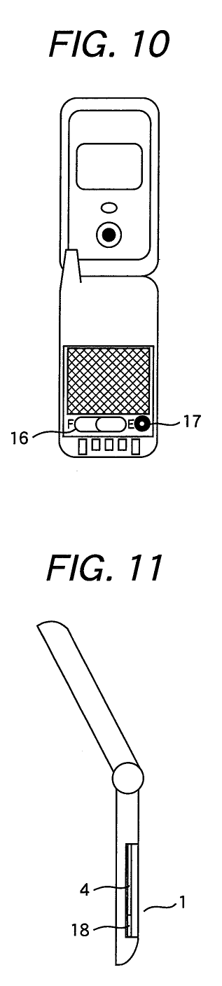

Next, the operation of the determining/control section 3 is explained in connection with flowcharts shown in FIG. 1, FIG. 4, FIG. 5, FIG. 6 and FIG. 7.

As shown in FIG. 4, the operation of the DC/DC converter 5 is stopped by making the restriction voltage Vlim low and the voltage of the fuel cell is measured by V_DMFC terminal. When open voltage value of the fuel cell is insufficient, the control section determine as fuel run out and inform the user through LED and go into sleep mode. If not fuel run out, DC/DC converter 5 is operated with restricted operation through a large resistance Rin. At this time, keeping OUT_PUT SW off state and preventing reverse current from flowing from the Li fuel pack 50 side.

As shown in FIG. 5, after that the determining/control section 3 is maintained at sleep state and waiting state during a predetermined time period, the fuel cell voltage Vout is determined under restricted operation of DC/DC converter 5, At this time, if the fuel cell voltage Vout is lower than the lower limit, any one of fuel run-out, air pole blocking and prevention by products is determined and determining/control section makes Vlim low and stop the fuel cell output.

If the fuel cell voltage is higher than a predetermined value, the determining/control section 3 makes Vlim 2 high to stop output restriction and turns on the output_switch to operate the fuel cell.

In the case accept above two as shown in FIG. 6, the determining/control section 3 keeps the restriction voltage Vlim at restriction state and turns on the output_switch 32 to operate the fuel cell 1 in a predetermined time period by its sleep function.

If the output of the fuel cell does not stay in stopping state after the above operation as shown in FIG. 7, the restriction voltage Vlim 2 is reduced to a low value and the operation of the DC/DC converter is stopped, and therefore the output of the fuel cell 1 goes into a step for recovering the characteristics of the fuel cell 1.

By the above control, it is possible to solve the problems. The normal operation recovers the voltage of the fuel cell after a predetermined time period. However, it may set so as to recover the output characteristics of the fuel cell 1 only by detection of lower limit voltage.

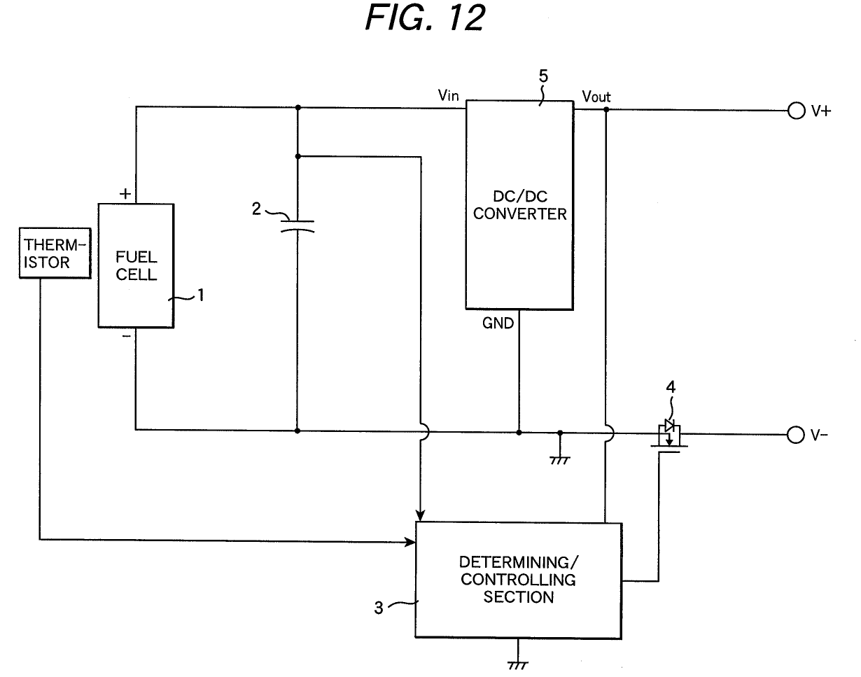

A control system shown in FIG. 12 recovers the output characteristics by rising up the voltage of the fuel cell. The present embodiment of the invention is featured in charging electric double layer capacitor from the fuel cell when the output voltage of the fuel cell rises up.

The embodiment provides two kinds of power source, such as a fuel cell and an electric double layer capacitor (EDLC). The fuel cell 1 is used as high energy density power source and the electric double layer capacitor 2 is used high power density power source in the embodiment. To simplify the structure, the fuel cell is desired to be a direct methanol fuel cell (DMFC). The number of the cell is so selected that the maximum voltage calculated from the number of series connected cell of the fuel cell necessary for the output does not exceed the withstand voltage of the electric double layer capacitor. Considering the maximum voltage (about 1.2 to 0.8) of a single cell, it is appropriate to determine the number of fuel cell within a range which one cell of the electric double layer capacitor corresponds to 2 to 4 fuel cells.

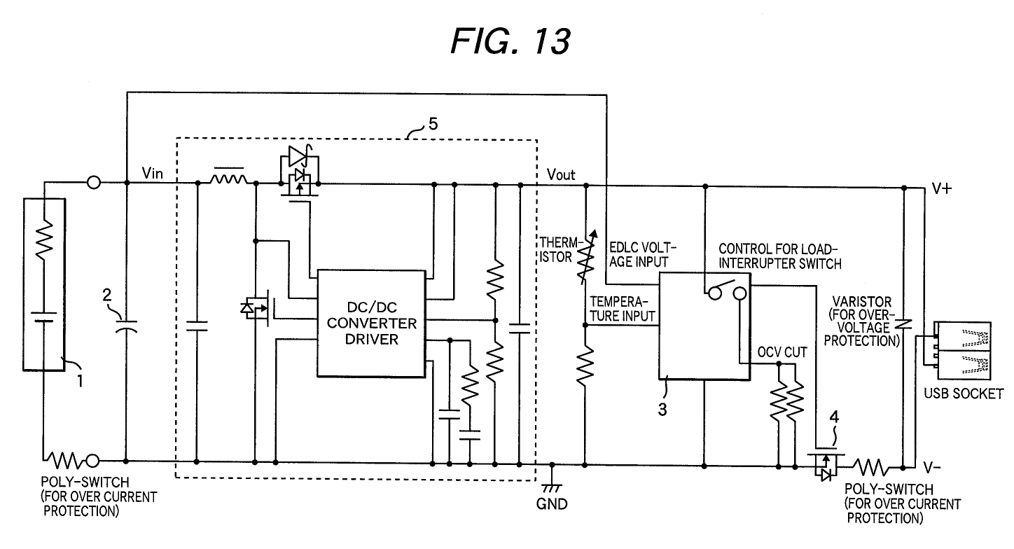

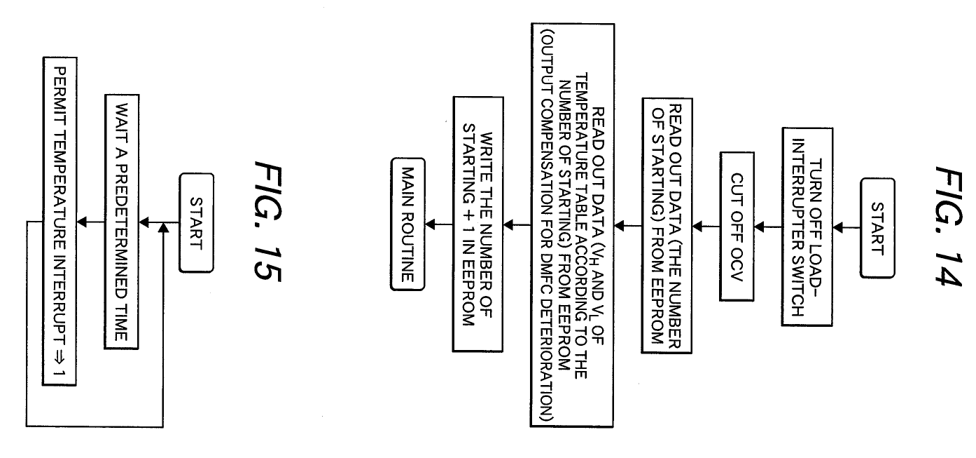

A circuit using two power sources includes a DC/DC converter 5 changing the voltage of the two power source into constant output voltage (voltage between Vout terminal and grand terminal), a load interruption switch 4 controlling feeding and interruption to the load, and a determining/control section 3 controlling the ON and OFF of the load interruption switch 4. An example of the DC/DC converter 5 is shown in FIG. 13 uses an insulation type (forward, feedback, push-pull etc) and chopper type voltage step up converter and it is more effective from the view point of reducing the number of cell of two kinds of power source mentioned above. However, either step down type or step up type is available.

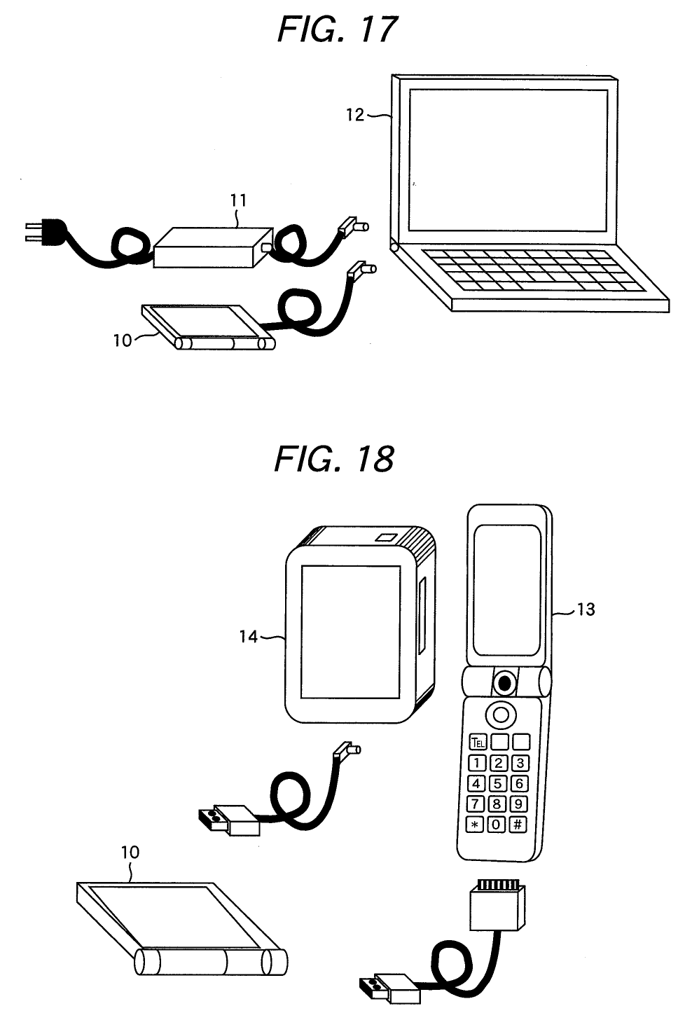

An embodiment of the power source system according to the present invention will now explained with respect to attached drawings, respectively. FIG. 17 shows an example of the power source system applied to the notebook type personal computer. The power source system is compatible to the AC adapter for the notebook type personal computer. The V+ and V− terminals in FIG. 13 are connectable to the AC adapter terminal of the notebook type personal computer and voltage (16V, 9V, 20V) compatible to the AC adapter is output between V+ and V− terminals by the DC/DC converter 5.

FIG. 18 shows an example of a typical Li secondary battery cell 1 mounted on the portable phone, PDA, MP3 player, portable media player. As shown in FIG. 18, the connection cord is selectable according to the devices by using the terminal of the power source side as a common terminal such as a USB terminal. 5V compatible to the USB voltage is output by the DC/DC converter 5 between V+ and V− terminals which are the connection terminal to the load. Not only using as a power source socket, it is possible to transfer many kinds of information relevant to fuel residue and power source codes to portable devices through the USB terminal.

Next, the control means and method of the invention are explained below. A one-chip microcomputer, a custom integral circuit (IC) and a comparator are used as the determining/control section 3. The determining/control section 3 provides A/D terminals and input output terminals. The input signals are voltage information of the electric double layer capacitor 2 and state judgment signals. On the other hand, output signals are ON/OFF control signal to the load interruption switch 4 and ON/OFF control signal to the DC/DC converter.

The starting step of the electric power source system is not shown in the drawings. However the control will be carried out according to the following:
(1) The user controls the ON-OFF of the electric devices, and the state is detected by a main switch.
(2) The determining/control section 3 is able to detect the fuel exchange and fuel cartridges by the user.
(3) In case of the structure which the fuel is directly fed to the fuel cell through the fuel exchange by the user. The voltage increase of the fuel cell is detectable through the input terminal and the A/D terminal of the determining/control section 3.

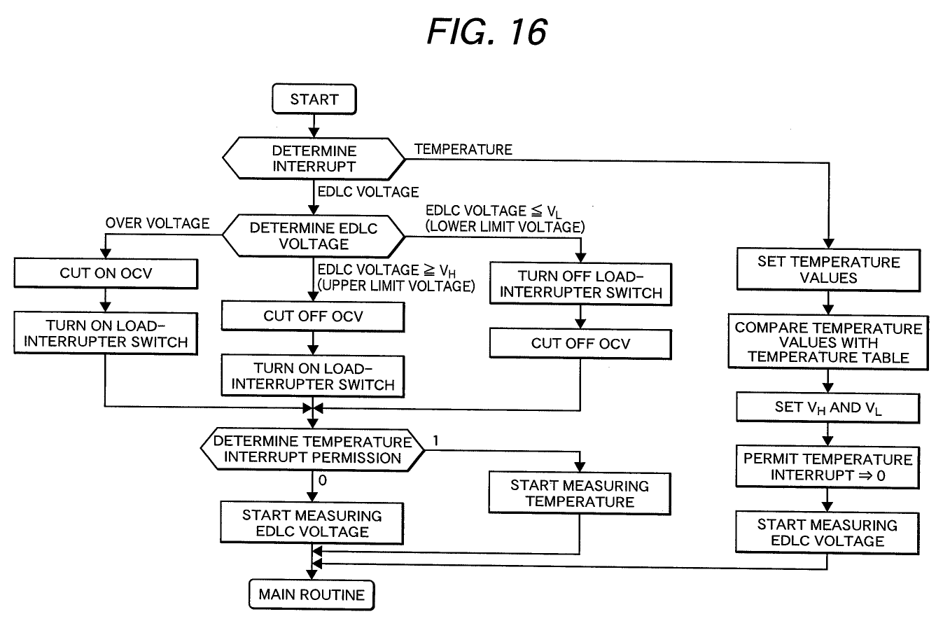

The normal operation of determining/control section 3 is explained with reference to the FIG. 14, FIG. 15 and FIG. 16.

As shown in FIG. 16, the discharging control begins when the determining/control section 3 detects through A/D port that the voltage of the electric double layer capacitor increases beyond set upper voltage limit. The determining/control section 3 turns on the load interruption switch 4 to begin to supply electric power to the devices.

In this state, both potentials of fuel cell as well as the electric double layer capacitor becomes almost same value and parallel supplying the power become possible. When the voltage of demand power is higher than that of the fuel cell, the fuel cell voltage and the electric double layer capacitor decreases according to the discharging time lapse.

Next, when the determining/control section 3 detects that the voltage of the electric double layer capacitor 2, fall down below the lower voltage limit through the A/D port, the charging control begins. The determining/control section 3 turn on load interruption switch 4 to cut off the power supply to the device and turn off the DC/DC converter 5.

In this state, the fuel cell 1 charges the electric double layer capacitor and the voltage of the electric double capacitor rises up according to the time lapse of the charging. After that when the voltage of the electric double layer capacitor rises over the upper voltage limit, the control section 4 restarts discharging and after that the routine is repeated

By repetition of the above routine, it is recognized from the device side as if the AC adapter is put in or taken out by a user, and change over action is carried out according to that. Therefore, so as not to cause abnormal action that put-in or take-out signals of AC adapter is quickly input to the device as if chattering caused. Control program and capacitance of the electric double layer capacitor is selected so as to be a sufficient long time period of the routine, for example, more than five seconds.

Although two embodiments are shown above, it is possible to combine and arrange the content of the embodiments according to its use.

What we claim is:

1. An electric power source system comprising:
a fuel cell;
an auxiliary power supply; and
a control section for decreasing the current from said fuel cell to reduce electric power load when the fuel cell voltage value reduces below the initial voltage value under predetermined constant power load, thereby increasing the fuel cell output voltage.

2. An electric power source system as set forth in claim 1, wherein the current from said fuel cell is increased after increasing of the fuel cell output voltage.

3. An electric power source system as set forth in claim 1, wherein the electric power load is decreased by reducing the current from said fuel cell when the fuel cell output voltage falls down below a predetermined value.

4. An electric power source system as set forth in claim 1, wherein current from said fuel cell is decreased to reduce the electric power load at every predetermined time, thereby increasing the fuel cell output voltage.

5. An electric power source system as set forth in claim 1, wherein said fuel cell is a direct methanol type.

6. An electric power source system as set forth in claim 1, said auxiliary power supply is a Li secondary battery.

7. An electric power source system as set forth in claim 1, wherein said auxiliary power supply is an electric double layer capacitor.

8. An electronic device mounting said electric power source system as set forth in claim 1.

9. An electric power device as set forth in claim 1, wherein said auxiliary power supply is a secondary battery and said secondary battery is discharged to a electronic device when the fuel cell voltage rises up.

10. An electric power source as set forth in claim 1, wherein said auxiliary power supply is an electric double layer capacitor and said fuel cell charges said electric double layer capacitor.

11. An electric power source as set forth in claim 1, further comprising a switch mechanism being capable of changing conduction or interruption of said power supply for electronic devices from said power supply, the fuel cell output voltage being increased by controlling said switch mechanism.

12. A control method of an electric power source system having a fuel cell, an auxiliary power supply and a control section, wherein said control section reduces the current from said fuel cell to reduce electric power load, thereby increasing the output voltage of said fuel cell.

13. An electric power source control method as set forth in claim 12, said control method carrying out recovery operation which reduces the current from said fuel cell to reduce the electric power load when the fuel cell voltage falls down below a predetermined value.

14. An electric power source system control method as set forth in claim 12, the recovery operation being carried out at every predetermined time.

15. An electric power source system control method as set forth in claim 12, the predetermined voltage value is higher than the value at a cross point where output current zero axis and the extension line of the output characteristics inclination to the fuel cell output current intersect each other.
